(19) United States
(12) Patent Application Publication
(10) Pub. No.: US 2026/0313092 A1
(43) Pub. Date: Oct. 8, 2026

(54) ADAPTIVE CROSS-COMPONENT PREDICTION FOR INTER CODED BLOCKS

(71) Applicant: InterDigital CE Patent Holdings, SAS, Paris (FR)

(72) Inventors: Fabrice LE LEANNEC, BETTON (FR); Ya CHEN, RENNES (FR); Franck GALPIN, THORIGNE-FOUILLARD (FR); Philippe BORDES, LAILLE (FR); Edouard FRANCOIS, BOURG DES COMPTES (FR)

(21) Appl. No.: 19/483,046

(22) PCT Filed: May 7, 2024
(86) PCT No.: PCT/EP2024/062522

§ 371 Date: Nov. 10, 2025

(30) Foreign Application Priority Data
May 11, 2023 (EP) 23315190.1
Jun. 22, 2023 (EP) 23305991.4

(51) Int. Cl. H04N 19/105; H04N 19/159; H04N 19/176; H04N 19/186

(52) U.S. Cl. CPC H04N 19/105; H04N 19/159; H04N 19/176; H04N 19/186

(57) ABSTRACT

A method and an apparatus for encoding or decoding a video are provided. A luma component of a block of the video is reconstructed. The video block being coded in an inter coding mode, a cross-component prediction mode for the video block is determined and one or more syntax elements are encoded for the video block, the one or more syntax elements providing for deriving the cross-component prediction mode on the decoder side from among a set of cross-component prediction modes. The chroma component of the video block is encoded based on the reconstructed luma component and the determined cross-component prediction mode.

This application claims the priority to European Patent Application No. 23315190.1 filed on 11 May 2023 and European Patent Application No. 23305991.4 filed on 22 Jun. 2023, which are incorporated herein by reference in its entirety.

### TECHNICAL FIELD

The present embodiments generally relate to video compression. The present embodiments relate to a method and an apparatus for encoding or decoding an image or a video. More particularly, the present embodiments relate to improving inter coding.

### BACKGROUND

To achieve high compression efficiency, image and video coding schemes usually employ prediction and transform to leverage spatial and temporal redundancy in the video content. Generally, intra or inter prediction is used to exploit the intra or inter picture correlation, then the differences between the original block and the predicted block, often denoted as prediction errors or prediction residuals, are transformed, quantized, and entropy coded. In inter prediction, motion vectors used in motion compensation are often predicted from motion vector predictor. To reconstruct the video, the compressed data are decoded by inverse processes corresponding to the entropy coding, quantization, transform, and prediction.

### SUMMARY

According to an aspect, a method for encoding a video is provided. The method comprises reconstructing a luma component of a block of the video, the video block being coded in an inter coding mode, determining a cross-component prediction mode for the video block, encoding one or more syntax elements for the video block, the one or more syntax elements providing for deriving the cross-component prediction mode on the decoder side from among a set of cross-component prediction modes, encoding the chroma component of the video block based on the reconstructed luma component and the determined cross-component prediction mode.

According to another aspect, an apparatus for encoding a video is provided. The apparatus comprises one or more processors operable to reconstruct a luma component of a block of the video, the video block being coded in an inter coding mode, determine a cross-component prediction mode for the video block, encode one or more syntax elements for the video block, the one or more syntax elements providing for deriving the cross-component prediction mode on the decoder side from among a set of cross-component prediction modes, encode the chroma component of the video block based on the reconstructed luma component and the determined cross-component prediction mode.

According to another aspect, a method for decoding a video is provided. The method comprises decoding one or more syntax elements for a block of the video, the video block being coded in an inter coding mode, determining a cross-component prediction mode for the video block from among a set of cross-component prediction modes, using the one or more syntax elements, reconstructing a luma component for the video block, reconstructing one or more chroma components for the video block from the reconstructed luma component using the cross-component prediction mode.

According to another aspect, an apparatus for decoding a video is provided. The apparatus comprises one or more processors operable to decode one or more syntax elements for a block of the video, the video block being coded in an inter coding mode, determine a cross-component prediction mode for the video block from among a set of cross-component prediction modes using the one or more syntax elements, reconstruct a luma component for the video block, reconstruct one or more chroma components for the video block from the reconstructed luma component using the cross-component prediction mode.

Further embodiments that can be used alone or in combination are described herein.

One or more embodiments also provide a computer program comprising instructions which when executed by one or more processors cause the one or more processors to perform the method for encoding/decoding a video according to any of the embodiments described herein. One or more of the present embodiments also provide a non-transitory computer readable medium and/or a computer readable storage medium having stored thereon instructions for encoding/decoding a video according to the methods described herein.

One or more embodiments also provide a computer readable storage medium having stored thereon a bitstream generated according to the methods described herein. One or more embodiments also provide a method and apparatus for transmitting or receiving the bitstream generated according to the methods described above.

### BRIEF DESCRIPTION OF THE DRAWINGS

FIG. 1 illustrates a block diagram of a system within which aspects of the present embodiments may be implemented.

FIG. 2 illustrates a block diagram of an embodiment of a video encoder within which aspects of the present embodiments may be implemented.

FIG. 3 illustrates a block diagram of an embodiment of a video decoder within which aspects of the present embodiments may be implemented.

FIG. 4 illustrates examples of locations of samples used for the derivation of the α and β parameters of a cross-component linear model.

FIG. 5 illustrates an effect of the slope adjustment parameter “u”, on the left is shown a model created with a regular CCLM and on the right a model updated with slope adjustment.

FIG. 6 illustrates an example of a spatial part of a convolutional filter in a convolutional cross-component model.

FIG. 7 illustrates an example of a reference area and its padding used to derive the filter coefficients of cross-component models.

FIG. 8 illustrates examples of four Sobel based gradient patterns for Gradient Linear Model.

FIG. 9 illustrates an example of a spatial part of the Gradient Linear CCCM convolutional filter.

FIG. 10 illustrates an example of a spatial part of a non-down sampled CCCM luma terms used for convolutional filter.

FIG. 11 illustrates examples of down-sampling filters applied on luma samples.

FIG. 12 illustrates an example of inter-CU prediction and reconstruction process with cross-component prediction.

FIG. 13 illustrates an example luma samples L0, . . . , L5 in relation to a chroma sample C FIG. 14 illustrates an example of a flowchart of a method for encoding a video block according to an embodiment.

FIG. 15 illustrates an example of a flowchart of a method for decoding a video block according to an embodiment.

FIG. 16 illustrates an example of a flowchart of a method for determining inter coding mode and cross-component prediction mode for encoding a video block according to a first variant.

FIG. 17 illustrates an example of a flowchart of a method for encoding the video block according to the first variant.

FIG. 18 illustrates an example of a flowchart of a method for decoding syntax relating to the video block according to the first variant.

FIG. 19 illustrates an example of a flowchart of a method for reconstructing the video block according to the first variant.

FIG. 20 illustrates an example of a flowchart of a method for decoding syntax relating to the video block according to a second variant.

FIG. 21 illustrates an example of a flowchart of a method for reconstructing the video block according to the second variant.

FIG. 22 illustrates an example of a flowchart of a method for reconstructing the video block according to a third variant.

FIG. 23 illustrates an example of a flowchart of a method for reconstructing the video block according to a fourth variant.

FIG. 24 illustrates a block diagram of a system within which aspects of the present embodiments may be implemented, according to another embodiment.

FIG. 25 shows two remote devices communicating over a communication network in accordance with an example of the present principles.

FIG. 26 shows the syntax of a signal in accordance with an example of the present principles.

### DETAILED DESCRIPTION

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

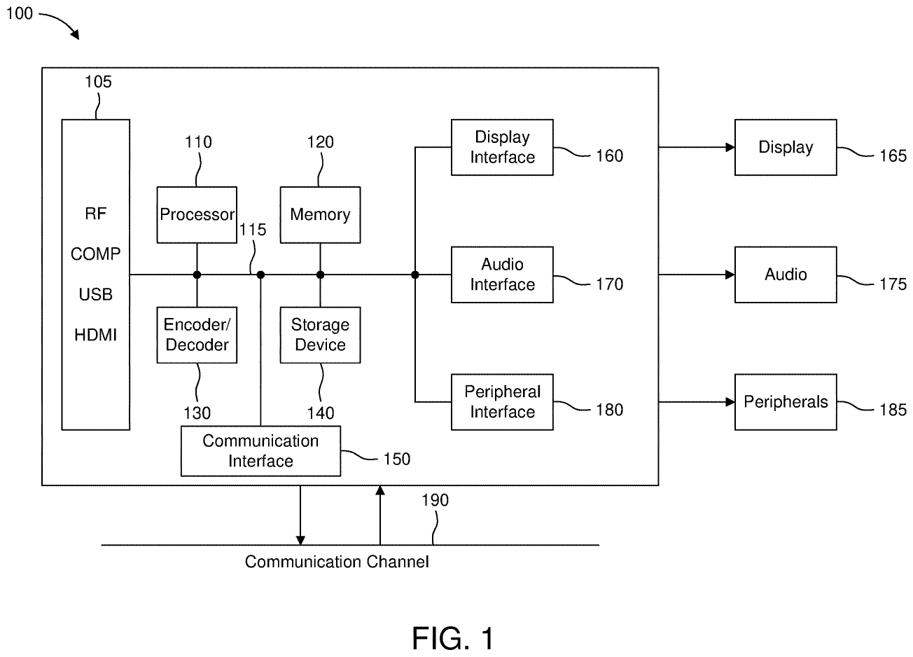

The aspects described and contemplated in this application can be implemented in many different forms. FIGS. 1, 2 and 3 below provide some embodiments, but other embodiments are contemplated and the discussion of FIGS. 1, 2 and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

The present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, standard developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the data stream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

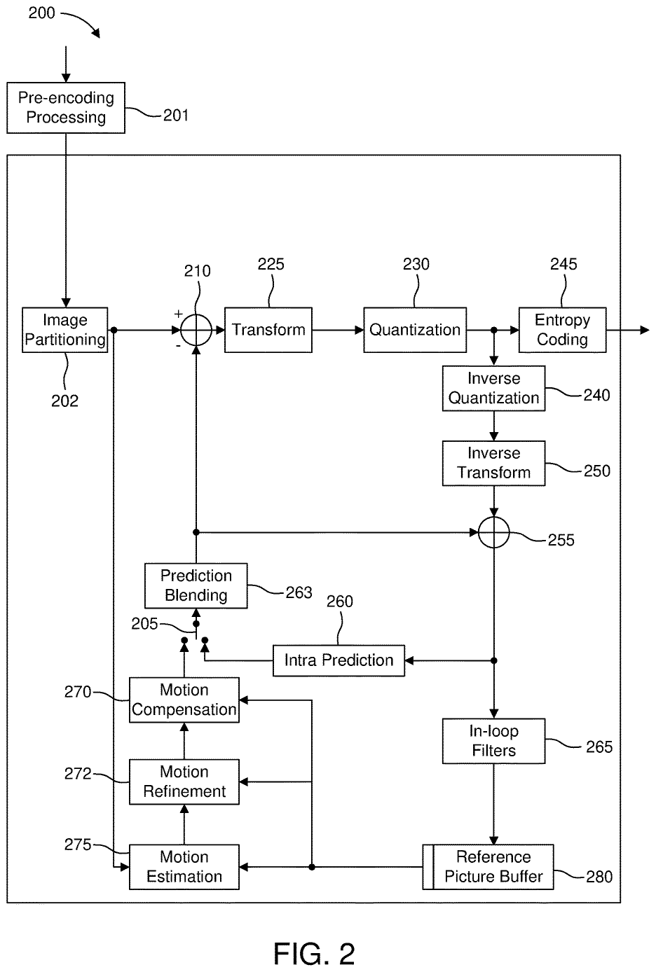

FIG. 2 illustrates an example of a block-based hybrid video encoder 200. Variations of this encoder 200 are contemplated, but the encoder 200 is described below for purposes of clarity without describing all expected variations.

In some embodiments, FIG. 2 also illustrate an encoder in which improvements are made to the HEVC standard or a VVC standard (Versatile Video Coding, Standard ITU-T H.266, ISO/IEC 23090-3, 2020) or an encoder employing technologies similar to HEVC or VVC, such as an encoder ECM under development by JVET (Joint Video Exploration Team).

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of color components), or re-sizing the picture (ex: down-scaling). Metadata can be associated with the pre-processing, and attached to the bitstream.

In the encoder 200, a picture is encoded by the encoder elements as described below. The picture to be encoded is partitioned (202) and processed in units of, for example, CUs (Coding units) or blocks. In the disclosure, different expressions may be used to refer to such a unit or block resulting from a partitioning of the picture. Such wording may be coding unit or CU, coding block or CB, luminance CB, or block. A CTU (Coding Tree Unit) may refer to a group of blocks or group of units. In some embodiments, a CTU may be considered as a block, or a unit as itself.

Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. The encoder may also blend (263) intra prediction result and inter prediction result, or blend results from different intra/inter prediction methods. Prediction residuals are calculated, for example, by subtracting (210) the predicted block from the original image block.

The motion refinement module (272) uses already available reference picture in order to refine the motion field of a block without reference to the original block. A motion field for a region can be considered as a collection of motion vectors for all pixels with the region. If the motion vectors are sub-block-based, the motion field can also be represented as the collection of all sub-block motion vectors in the region (all pixels within a sub-block has the same motion vector, and the motion vectors may vary from sub-block to sub-block). If a single motion vector is used for the region, the motion field for the region can also be represented by the single motion vector (same motion vectors for all pixels in the region).

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

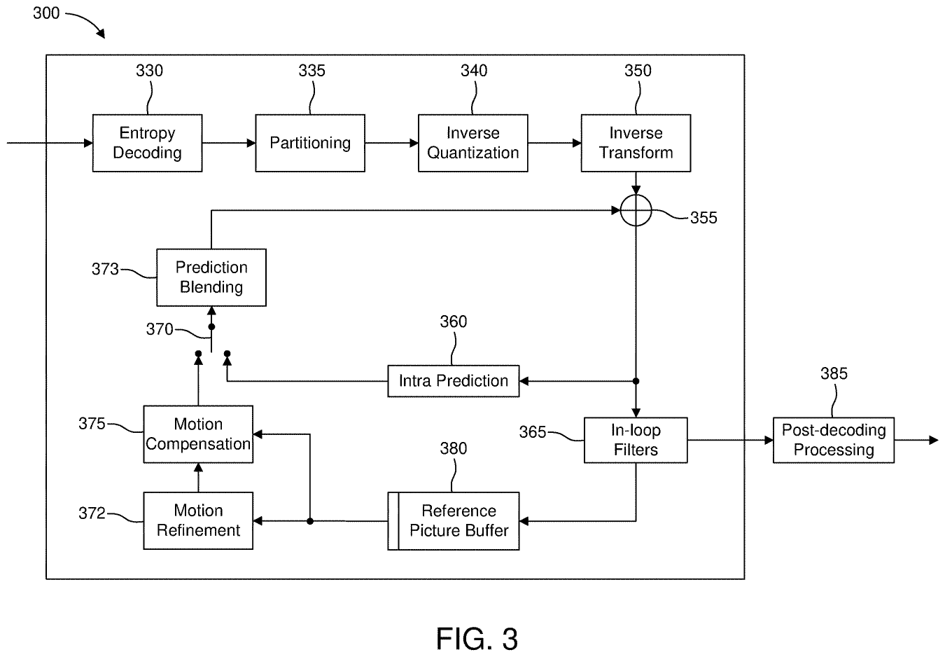

FIG. 3 illustrates a block diagram of a video decoder 300. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed.

The predicted block can be obtained (370) from intra prediction (360) or motion-compensated prediction (i.e., inter prediction) (375). The decoder may blend (373) the intra prediction result and inter prediction result, or blend results from multiple intra/inter prediction methods. Before motion compensation, the motion field may be refined (372) by using already available reference pictures. In-loop filters (365) are applied to the reconstructed image. The filtered image is stored at a reference picture buffer (380).

The decoded picture can further go through post-decoding processing (385), for example, an inverse color transform (e.g. conversion from YCbCr 4:2:0 to RGB 4:4:4) or an inverse remapping performing the inverse of the remapping process performed in the pre-encoding processing (201), or re-sizing the reconstructed pictures (ex: up-scaling). The post-decoding processing can use metadata derived in the pre-encoding processing and signaled in the bitstream.

Some of the embodiments described herein relates to inter prediction and more particularly to adaptive cross-component prediction for inter coded blocks.

Any one of the embodiments described herein can be implemented for instance in an inter prediction module of a video encoder or video decoder. For instance, the embodiments described herein can be implemented in the motion compensation module 270 of the video encoder 200 or the motion compensation module 375 of the video decoder 300.

Cross-component linear model (CCLM) for intra prediction is implemented in ECM 7 (M. Coban, F. Le Leannec, R-L. Liao, K. Naser, J. Ström, L. Zhang, “Algorithm description of Enhanced Compression Model 7 (ECM 7),” document JVET-AB2025, 28th Meeting, by teleconference, October 2022). In CCLM, the chroma samples are predicted based on the reconstructed luma samples of the same CU by using a linear model as follows:

$$pred\_C ( i , j ) = α \cdot {rec\_L}^{′} ( i , j ) + β \qquad ( eq . 1 )$$

where pred_C (i,j) represents the predicted chroma samples in a CU and rec_L (i,j) represents the downsampled reconstructed luma samples of the same CU.

The CCLM parameters (α and β) are derived from neighbouring chroma samples (top row and left column) and their corresponding down-sampled luma samples (LM mode).

In a variant, at most four neighbouring chroma samples are used. In another variant, the neighbouring chroma samples are selected from top only (LM-A), or left only (LM-L) and the selected mode is signaled to the decoder.

The selected neighbouring luma samples at the selected positions are downsampled and compared to find two smaller values: x⁰_{A} and x¹_{A}, and two larger values: x⁰_{B} and x¹_{B}. Their corresponding chroma sample values are denoted as y⁰_{A}, y¹_{A}, y⁰_{B} and y¹_{B}. Then Xₐ, X_{b}, Yₐ and Y_{b} are derived as:

$${X}_{a} = ( {x}_{A}^{0} + {x}_{A}^{1} + 1 ) ≫ 1$$

$${X}_{b} = ( {x}_{B}^{0} + {x}_{B}^{1} + 1 ) ≫ 1$$

$${Y}_{a} = ( {y}_{A}^{0} + {y}_{A}^{1} + 1 ) ≫ 1$$

$${Y}_{b} = ( {y}_{B}^{0} + {y}_{B}^{1} + 1 ) ≫ 1$$

Finally, the linear model parameters α and β are obtained according to the following equations:

$$A = \frac{{Y}_{a} - {Y}_{b}}{{X}_{a} - {X}_{b}}$$

$$β = {Y}_{b} - α \cdot {X}_{b}$$

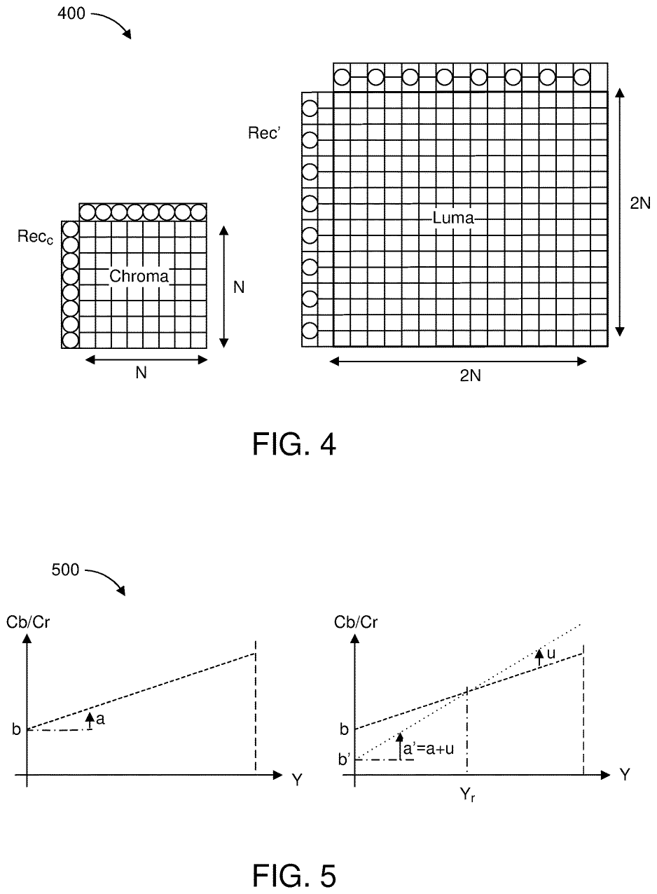

FIG. 4 (400) shows an example of the location of the left and above samples Rec′_{L} for luma components and left and above samples Rec_{c} for chroma components (left and above samples are illustrated with circles on FIG. 4) and the samples of a current 2N×2N block involved in the CCLM mode.

In another variant, three Multi-model LM (MMLM) modes are added. In each MMLM mode, the reconstructed neighboring samples are classified into two classes using a threshold which is the average of the luma reconstructed neighboring samples. The linear model of each class is derived using the Least-Mean-Square (LMS) method. For the CCLM mode, the LMS method is also used to derive the linear model.

In another variant, a slope adjustment is applied to the cross-component linear model (CCLM) and to the Multi-model LM prediction. The adjustment is tilting the linear function which maps luma values to chroma values with respect to a center point determined by the average luma value of the reference samples, as depicted in FIG. 5 (500) wherein on the left is shown a model created with a regular CCLM having a and b parameters and on the right the model updated with slope adjustment parameter u, Yₜ being the average luma value of the reference samples.

In ECM7, a Convolutional cross-component model (CCCM) is also implemented for intra prediction. The convolutional cross-component model (CCCM) predicts chroma samples from reconstructed luma samples in a similar manner as done by CCLM. The reconstructed luma samples are down-sampled to match the lower resolution chroma grid when chroma sub-sampling is used.

Also, there is an option of using a single model or multi-model variant of CCCM. Multi-model CCCM mode can be selected for blocks which have at least 128 reference samples available. The multi-model variant uses two models, one model applied to samples values higher than the average luma reference value and another model for the rest of the samples (following the spirit of the CCLM design).

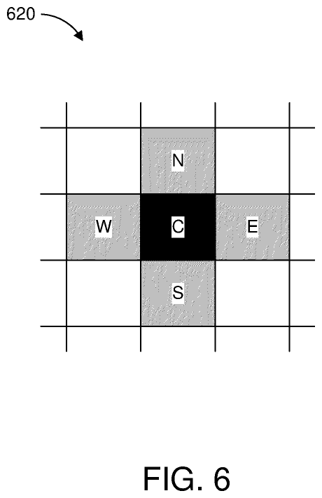

CCCM uses a convolutional filter made of 7 parameters weighting 7 inputs samples {sᵢ}_{i=0, . . . 6}. 5 coefficients are applied to luminance pixel values corresponding to a plus sign shape, one coefficient to a square term (P) and the last coefficient to a bias term (B). The input to the spatial 5-tap component of the filter consists of a center (C) luma sample which is collocated with the chroma sample to be predicted and its above/north (N), below/south(S), left/west (W) and right/east (E) neighbors as illustrated in FIG. 6 (620).

A term P is represented as the power of two of the center luma sample C and scaled to the sample value range of the content:

$$P = ( {C}^{*} C + midVal ) ≫ bitDepth$$

Where midVal is a rounding term. That is, for 10-bit content it is calculated as:

$$P = ( {C}^{*} C + 512 ) ≫ 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$predChromaVal = {c}_{0} C + {c}_{1} N + {c}_{2} S + {c}_{3} E + c 4 W + {c}_{5} P + {c}_{6} B \qquad ( eq . 2 )$$

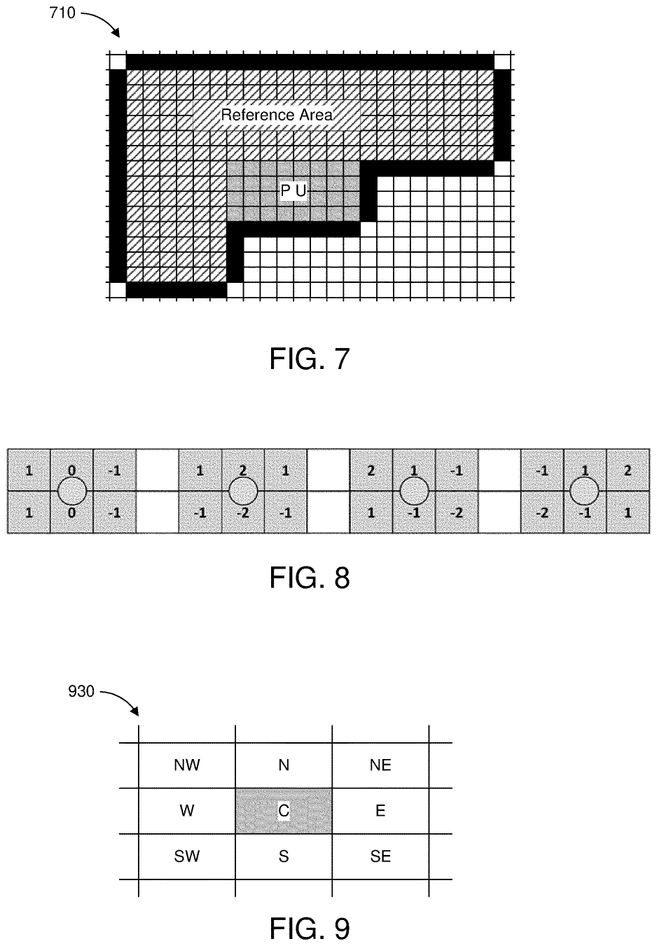

The filter coefficients cᵢ are calculated by minimizing MSE between predicted and reconstructed chroma samples in a reference area (710). FIG. 7 (710) illustrates an example of a reference area which consists of 6 lines/columns of chroma samples above and left of the block/PU. Reference area extends one PU width to the right and one PU height below the PU boundaries. Area is adjusted to include only available samples. The extensions to the reference area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output.

$$denote s = ( \begin{matrix}C \\ N \\ S \\ E \\ W \\ P \\ B\end{matrix} ) where {s}_{i} = \{ \begin{matrix}i = 0 : C \\ i = 1 : N \\ i = 2 : S \\ i = 3 : E \\ i = 4 : W \\ i = 5 : P \\ i = 6 : B\end{matrix}$$

To derive the coefficients {cᵢ}, the autocorrelation matrix is inverted. For example, the autocorrelation matrix is LDL^{T} decomposed and the final filter coefficients are calculated using back-substitution. The process follows roughly the calculation of the ALF filter coefficients in ECM, however LDL^{T} decomposition (a.k.a alternative Cholesky decomposition) was chosen instead of Cholesky decomposition to avoid using square root operations. In another variant, Gaussian elimination technique is used to invert the matrix as in the VVC standard. In ECM, the calculation uses integer 64-bits arithmetic.

In ECM7, Gradient Linear Model is also provided. For YUV 4:2:0 color format, a gradient linear model (GLM) method can be used to predict the chroma samples from luma sample gradients. Two modes are supported: a two-parameter GLM mode and a three-parameter GLM mode. Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

In the three-parameter GLM, a chroma sample can be predicted based on both the luma sample gradients and down-sampled luma values with different parameters. The model parameters of the three-parameter GLM are derived from 6 rows and columns adjacent samples by the LDL decomposition based MSE minimization method as used in the CCCM.

$$C = {α}_{0} \cdot G + {α}_{1} \cdot L + {α}_{2} \cdot β$$

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of 4 gradient filters for the gradient calculation. Four gradient filters are enabled for the GLM, as illustrated in FIG. 8

In ECM7, Gradient and location based convolutional cross-component model (GL-CCCM) is also provided. This is a variant of CCCM where the convolution applies on gradient and location information instead of the 4 spatial neighbor samples in the CCCM filter as in VVC. This variant is shown on FIG. 9 (930). The GL-CCCM filter for the prediction is:

$$predChromaVal = c 0 C + c 1 Gy + c 2 Gx + c 3 Y + c 4 X + c 5 P + c 6 B \qquad ( eq . 3 )$$

Where Gy and Gx are the luma vertical and horizontal gradients, respectively, and are calculated as (see 930 FIG. 9):

$$Gy = ( 2 N + NW + NE ) - ( 2 S + SW + SE )$$

$$Gx = ( 2 W + NW + SW ) - ( 2 E + NE + SE )$$

Moreover, the Y and X parameters are the vertical and horizontal coordinates of the center luma sample location.

The rest of the parameters are the same as CCCM tool. The reference area for the parameter calculation is the same as CCCM method.

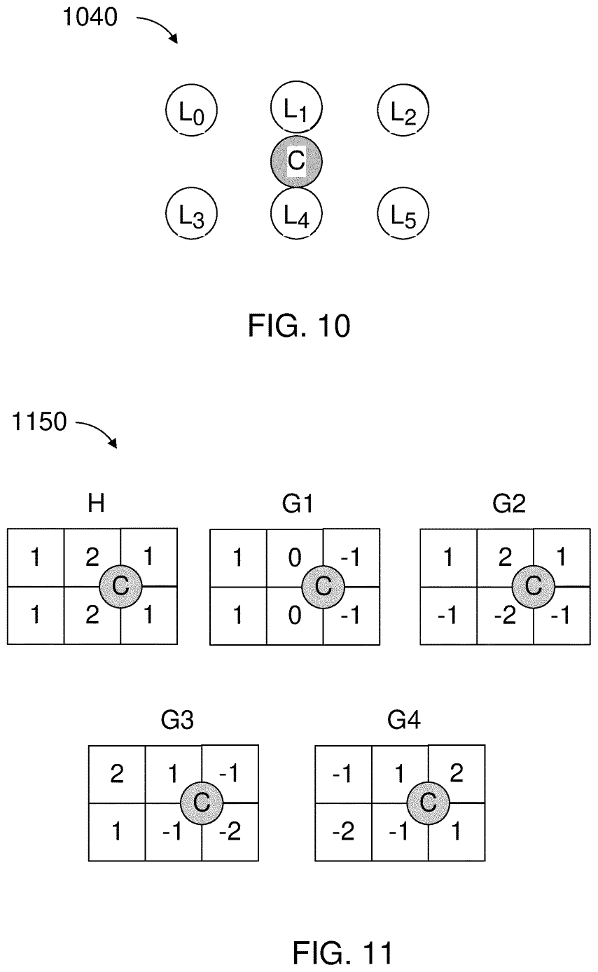

In another variant, the reconstructed luma samples are not down-sampled to match the lower resolution chroma grid and the co-located reconstructed 6 luma samples are used directly as depicted in FIG. 10. In this variant, also 4 terms are used built from L₀, L₁, L₂ and L₄ plus the bias B (VVC). Then the number of parameters is 10.

In another variant, multiple (for example 4) down-sampling filters may be used to derive the input samples to be weighted with the coefficients. The down-sampling filter model is signaled per CU and the prediction of the chroma samples is derived as follows:

$$predChroma = c {0}^{*} H ( C ) + c {1}^{*} G 1 ( C ) + c {2}^{*} G 2 ( C ) + c {3}^{*} G 3 ( C ) + c {4}^{*} G 4 ( C ) + c {5}^{*} P + c {6}^{*} B \qquad Model 1$$

$$predChroma = c {0}^{*} H ( C ) + c {1}^{*} H ( W ) + c {2}^{*} H ( E ) + c {3}^{*} G 1 ( C ) + c {4}^{*} G 1 ( W ) + c {5}^{*} G 1 ( E ) + c {6}^{*} B \qquad Model 2$$

$$predChroma = c {0}^{*} H ( C ) + c {1}^{*} H ( N ) + c {2}^{*} H ( S ) + c {3}^{*} G 2 ( C ) + c {4}^{*} G 2 ( N ) + c {5}^{*} G 2 ( S ) + c {6}^{*} B \qquad Model 3$$

$$predChroma = c {0}^{*} H ( C ) + c {1}^{*} H ( NE ) + c {2}^{*} H ( SW ) + c {3}^{*} G 4 ( C ) + c {4}^{*} G 4 ( NE ) + c {5}^{*} G 4 ( SW ) + c {6}^{*} B \qquad Model 4$$

$$where H ( \cdot ) , G 1 ( \cdot ) , G 2 ( \cdot ) , G 3 ( \cdot ) , G 4 ( \cdot ) are downsampling filters applied on luma samples as indicated in FIG . 11 ( 1150 ) .$$

In K. Zhang, L. Zhang, Z. Deng, Chia-Ming Tsai, Hsin-Yi Tseng, Cheng-Yen Chuang, Chih-Wei Hsu, Ching-Yeh Chen, Tzu-Der Chuang, Olena Chubach, Yi-Wen Chen, Yu-Wen Huang, Shaw-Min Lei, “EE2-1.6: Non-local cross-component prediction and cross-component merge mode” document JVET-AD0188, 30th Meeting, by teleconference, 21-28 Apr. 2023, non-local cross-component prediction and cross-component merge mode are provided.

In ECM, for intra blocks, a CU-level choice of the luma to chroma cross-component prediction mode is enabled, and some syntax elements (LMCMode flag, cclmFlag, mmlmFlag, cccmFlag, cccmNoSubFlag, glCccmFlag, glmFlag). Therefore, JVET-AD0188 proposes to allow the derivation of the cross-component prediction (CCP) used for a given block, from already coded blocks in same picture.

A CCP merge candidate list is constructed. For instance, the CCP merge candidate list comprises spatial adjacent candidates, spatial non-adjacent candidates, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighboring template of the current block. More details are described below:

Spatial adjacent and non-adjacent candidates: The positions and inclusion order of the spatial adjacent and non-adjacent candidates are the same as those defined in ECM for regular inter merge prediction candidates.

History-based candidates: A history-based table is maintained to include the recently used CCP models, and the table is reset at the beginning of each CTU row. If the current list is not full after including spatial adjacent and non-adjacent candidates, the CCP models in the history-based table are added into the list.

Default candidates: CCLM candidates with default scaling parameters are considered, only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+ {⅛, −⅛, 2/8, − 2/8, ⅜, −⅜, 4/8, − 4/8, ⅝, −⅝, 6/8}}. The offset parameter is derived according to the default scaling parameter, average neighbouring reconstructed luma sample value, and average neighbouring reconstructed Cb/Cr sample value.

A flag is signaled to indicate whether the CCP merge mode is applied or not. If CCP merge mode is applied, an index is signaled to indicate which candidate model is used by the current block. In addition, CCP merge mode is not allowed for the current chroma coding block when the current CU is coded by intra subpartitions (ISP) with single tree, or the current chroma coding block size is less than or equal to 16.

In P. Astola, J. Lainema (Nokia), “AHG12: Cross-component residual model (CCRM) for inter prediction”, document JVET-AD0108, April 2023, Cross-component residual model (CCRM) is provided for inter prediction. A 8-tap filter consisting of 6 spatial luma samples, a nonlinear term, and a bias term is used for the prediction of the chroma using only the luma channel for inter coded blocks. The spatial luma samples (L0, . . . , L5) are obtained from the luma grid selecting the 6 luma samples closest to the chroma position C without down sampling as shown in FIG. 13. FIG. 13 shows luma samples L0, . . . L5 in relation to chroma sample C in a half-pel luma grid.

The predicted chroma value is obtained as:
predChromaVal=c₀ L0+c₁L1+c₂L2+c₃L3+c₄L4+c₅L5+c₆ nonlinear ((L0+L3+1)>>1)+c₇ B, where nonlinear is CCCM's nonlinear operator and B is bias.

The filter coefficients are derived using ECM's division-free Gaussian elimination method and the necessary offsets are applied to samples prior to filter derivation.

Intra reference samples are used as additional input samples in filter derivation when the block has less than 64 chroma samples. CCCM's design of at most 6 rows and columns of intra reference samples is used.

Blocks having 256 chroma samples or more are divided into subblocks that have at most 256 chroma samples. Subblocks containing zero luma residual are skipped.

The CCRM tool is currently used in replacement of the temporal chroma prediction (that is the prediction that uses the motion compensated chroma) commonly used in inter-prediction of chroma components. A limitation of CCRM approach of JVET-AD0108 is that a single CCP method is used to predict chroma from luma in an inter block, whereas for intra blocks several possible CCP methods are allowed.

As a consequence, the compression performance of inter blocks may be limited due to this lack of flexibility in the CCP in inter blocks.

An aim of the embodiments provided herein is to introduce more flexibility in the choice of CCP methods for inter blocks, so as to increase the compression efficiency of state-of-the-art video codecs.

In some embodiments, the CCP of inter blocks is improved by introducing the possibility to use a CCP method (also called CCP mode in the following) for inter blocks among a various set of CCP methods. In the present document, the term “block” can also be referred to prediction unit (PU) or coding unit (CU) as is commonly used in video coding standards or implementations.

FIG. 14 illustrates an example of a method (1400) for encoding a video block according to an embodiment. In this embodiment, the video block is coded using an inter mode or inter prediction. It is thus called in the following an inter block. At 1401, the luma part of the considered inter block is predicted according to an inter prediction mode determined for the inter block and reconstructed. For instance, a reference block is determined in a reference picture using motion compensation for the inter block using motion data determined for the inter block. On the encoder side, at 1402, among a variety of CCP modes, one CCP mode is selected for the inter block. The selected CCP method for the inter block is then signaled (1403) in a bitstream encoding the video. This signaling can be explicit (that is under the form of syntax element(s) used to identify the CCP mode) or implicit (that is under the form of syntax elements used at decoder side to derive the CCP mode of the current inter block). In some embodiments, only the use of a CCP mode is signaled, the selected CCP mode is determined in a same manner on the encoder and decoder side, for instance using a template (reconstructed samples surrounding the inter block) of the inter block or a reference block of the inter block. At 1404, the chroma parts of the inter block are encoded based on the selected CCP mode along with the inter block data, such as inter prediction mode, luma data, etc.,

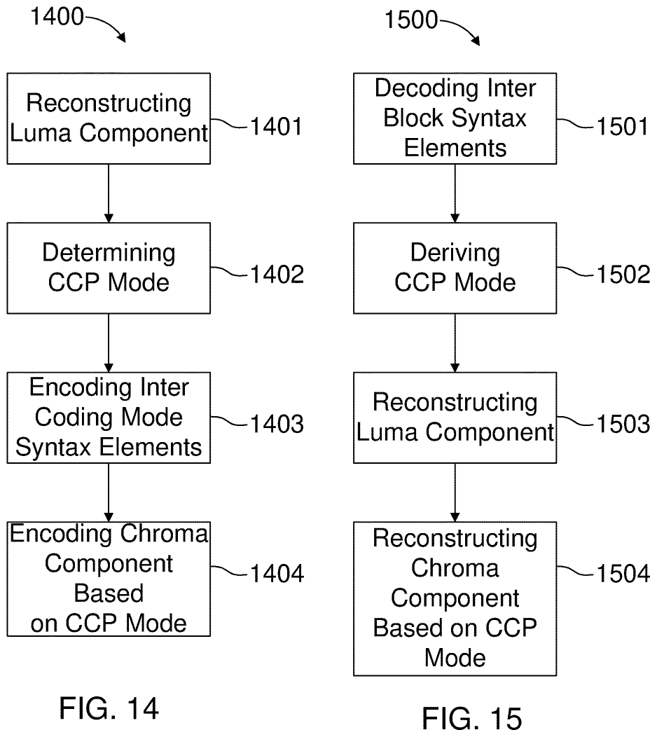

FIG. 15 illustrates an example of a method (1500) for decoding a video block according to an embodiment. On the decoder side, the syntax elements associated to the video block are parsed (1501), that is decoded from the bitstream. In this embodiment, the video block is coded using an inter mode or inter prediction. It is thus called in the following an inter block. The parsed syntax elements for the inter block are used to identify the CCP mode used for that inter block. In some embodiments, only the use of a CCP mode is signaled, the selected CCP mode is determined in a same manner on the encoder and decoder side, for instance using a template or a reference block of the inter block. At 1502, the CCP mode used for the given inter block is derived from the decoded syntax elements. The luma part of the considered inter block is reconstructed (1503) and the chroma parts (Cb and Cr blocks) of the inter block are predicted and reconstructed (1504) from the reconstructed luma block, according to the CCP mode used for the current inter block.

Several variants of the embodiments provided above can include the following aspects which can be used alone or in combination.

When the inter block is coded in an AMVP mode, the use of a CCP mode and the selected CCP mode are signaled explicitly together with motion data. For instance, the AMVP mode is an inter prediction coding mode as is known in the VVC standard. More generally, the AMVP mode is an inter-prediction coding mode wherein a motion vector difference (mvd) with respect to a motion predictor is coded. The motion predictor can be for instance signaled in the bitstream by an index indicating a motion predictor candidate from a motion candidate list.

In another variant, when the inter block is coded in a merge mode, the CCP mode of the inter block can be derived at the decoder side in a same way as the motion data derivation process for the inter block. For instance, the merge mode is an inter prediction coding mode as is known in the VVC standard. More generally, the merge mode is an inter-prediction coding mode wherein the motion vector difference (mvd) with respect to a motion predictor is inferred to be zero. The motion predictor can be for instance signaled in the bitstream by an index indicating a motion predictor candidate from a merge candidate list.

The merge candidate list, for example as designed in an existing video codec, is used jointly for deriving motion information and CCP mode information derivation from block to block. This way, the merge_idx syntax element of inter block is used both for motion information derivation and CCP mode derivation. When an inter block inherits the motion of a merge candidate, it also inherits the CCP method of that merge candidate.

Alternatively, a separate merge index dedicated to CCP mode derivation is signaled at PU or CU level.

In another variant, the CCP mode derivation may also apply to the temporal merge derivation. When a TMVP (Temporal motion vector predictor) or SbTMVP (Subblock Temporal motion vector predictor) motion vector is inherited, the associated CCP mode may also be inherited from the temporal candidate. For instance, the TMVP and SbTMVP motion vector are obtained as in the VVC standard or the ECM implementation.

In another variant, the CCP mode derivation may only apply when the inter block is in skip mode. In such case, the inter block may inherit the CCP mode from a merge candidate selected in a candidate list, similarly as for motion information.

In another variant, the CCP mode derivation may only apply when the merge candidate used for deriving the motion data corresponds to a spatial neighboring block of the current inter block. In that variant, no non-adjacent merge candidate may be used to derive the CCP method of the given inter block.

In another variant, the CCP mode chosen for the inter block may be the one minimizing a distortion between the filtered predicted luma block and the predicted chroma block. In other words, the CCP mode does not need to be signaled as the same process is done on the encoder side and the decoder side to select the CCP mode. This distortion is determined between the chroma parts of the temporally predicted inter block and a prediction of the chroma parts of the inter block from the temporally predicted luma parts of the current inter block using a candidate CCP mode. The CCP mode leading to minimum distortion among all CCP candidate modes is selected at encoder and decoder sides.

In another variant, the CCP mode inheritance may further include the inheritance of CCP filtering parameter in addition to the CCP prediction mode itself.

In a further variant, these CCP parameters may only be inherited when the current inter block is in skip mode. In a further variant, these CCP parameters may only be inherited when a spatially adjacent merge candidate is used for derivation.

In another variant, the set and the number of available CCP modes may be dependent on the inter mode, for instance, they can be dependent whether the inter mode is AMVP, merge, TMVP, SbTMVP.

In another variant, the CCP modes may be re-ordered using a template of the current inter block. For each (or a subset of) CCP mode candidates, the CCP mode is used to predict reconstructed samples of the template and a cost of the CCP mode is determined on this template. The CCP mode costs are used to re-order the CCP mode candidates.

In some embodiments, a cross-component prediction mode is signaled at block level for an inter block, among a plurality of possible cross-component modes. This plurality of cross-component modes can include all or part of the following modes described further above: CCLM, MMLM, CCCM, GLM, GLCCCM.

In terms of coding unit syntax modification of an existing video codec implementation, for instance the ECM 7 under study, this signaling can take the form of the following table 1.

As can be seen, in the case of an inter CU, some syntax elements are added to the existing bit-stream syntax, in order to identify a cross-component prediction mode used for the given inter CU. The added elements are shown in bold in table 1.

In this embodiment, for each CU, a flag inter_ccp_mode_flag is signaled to indicate use of a CCP mode to predict the chroma coding blocks of the considered CU. If this flag is on, then further syntax elements may be signaled to allow the video decoder to identify the CCP mode actually used for the current CU. This takes the form of the inter_ccp_mode( ) syntax structures illustrated on table 1 below.

TABLE 1
proposed syntax modification to support multiple CCP modes for inter CUs

| | Descriptor |
|---|---|
| coding_unit( x0, y0, cbWidth, cbHeight, cqtDepth, treeType, modeType ) { | |
| if( sh_slice_type = = I && ( cbWidth > 64 \|\| cbHeight > 64 ) ) | |
| modeType = MODE_TYPE_INTRA | |
| chType = treeType = = DUAL_TREE_CHROMA ? 1 : 0 | |
| if( sh_slice_type != I \|\| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \|\| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != I && | |
| !( cbWidth = = 4 && cbHeight = 4 ) && modeType = = | |
| MODE_TYPE_ALL ) | |
| pred_mode_flag | ae(v) |
| if( ( ( sh_slice_type = = I && cu_skip_flag[ x0 ][ y0 ] = =0 ) \|\| | |
| ( sh_slice_type != I && ( CuPredMode[ chType ][ x0 ][ y0 ] != | |
| MODE_INTRA \|\| | |
| ( ( ( cbWidth = = 4 && cbHeight = = 4 ) \|\| modeType = = | |
| MODE_TYPE_INTRA ) | |
| && cu_skip_flag[ x0 ][ y0 ] = = 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| } | |
| [ ... ] | |
| if( CuPredMode[ chType ][ x0 ][ y0 ] = = MODE_INTRA \|\| | |
| CuPredMode[ chType ][ x0 ][ y0 ] = = MODE_PLT ) { | |
| [ ... ] | |
| } else if( treeType != DUAL_TREE_CHROMA ) { /* MODE_INTER or MODE_IBC | |
| */ | |
| If( CcpAllowed( x0 , y0 ) { | |
| inter_ccp_mode_flag[ x0 ][ y0 ] | ae(v) |
| if( inter_ccp_mode_flag[ x0 ][ y0 ] = = 1 ) { | |
| Inter_ccp_mode | |
| ( x0, y0, cbWidth, cbHeight, cqtDepth, treeType, modeType ) | |
| } | |
| } | |
| if( cu_skip_flag[ x0 ][ y0 ] = = 0 ) | |
| general_merge_flag[ x0 ][ y0 ] | ae(v) |
| if( general_merge_flag[ x0 ][ y0 ] ) | |
| merge_data( x0, y0, cbWidth, cbHeight, chType ) | |
| else if( CuPredMode[ chType ][ x0 ][ y0 ] = = MODE_IBC ) { | |
| [...] | ae(v) |
| } else { | |
| [... ] // AMVP motion data signaling | |
| } | |
| } | |
| [ ...] // CU residual data signaling | |
| } | |

The function CcpAllowed(x0, y0) is a function determining if cross-component prediction is allowed for the current block (x0,y0). For instance, it checks whether some conditions are satisfied from cross-prediction to be allowed for the current block (x0, y0).

The following table 2 shows an example of possible syntax arrangement to indicate the CCP mode and CCP parameters used to code a given inter block, among known cross-component prediction methods (CCLM, MMLM, MDLM, GLM, GLCCCM).

TABLE 2
proposed signaling for CCP mode and CCP parameters for Chroma blocks

| | Descriptor |
|---|---|
| inter_ccp_mode( x0, y0, cbWidth, cbHeight, cqtDepth, treeType, modeType) { | |
| cclm_flag | ae(v) |
| If ( cclm_flag == 0 ) { | |
| ccp_mode_idx // MMLM, MDLM_L, MDLM_T, MMLM_L or MMLM_T | ae(v) |
| } | |
| If ( CccmAllowed( x0 , y0 ) ) { | |
| cccm_flag | ae(v) |
| cccm_no_sub_sampling_flag | |
| If (cccm_no_sub_sampling_flag ){ | |
| gl_cccm_flag | |
| } | |
| If (GlmAllowed( x0, y0 ) { | |
| glm_flag | |
| If ( glm_flag == 1) { | |
| glm_idx | |
| } | |
| } | |
| } | |
| If ( ( cclm_flag == 1 \|\| ccp_mode_idx == MMLM \|\| ccp_mode_idx == MMLM_L | |
| \|\| ccp_mode_idx == MMLT) && glm_flag == 0 cbWidth*cbHeight>= 128 | |
| && cbWidth*cbHeight>= 128 ) | |
| cclm_delta_flag | |
| If ( cclm_delta_flag == 1 ) { | |
| cclm_cb0_flag | |
| cclm_cr0_flag | |
| If ( cclm_cb0_flag ) { | |
| cclm_cb0_delta_idx | |
| } | |
| If ( cclm_cr0_flag ) { | |
| cclm_cr0_delta_idx | |
| } | |
| If (ccp_mode_idx == MMLM \|\| ccp_mode_idx == MMLM_L \|\| ccp_mode_idx | |
| == MMLT) { | |
| cclm_cb1_flag | |
| cclm_cr1_flag | |
| If ( cclm_cb1_flag ) { | |
| cclm_cb1delta_idx | |
| } | |
| If ( cclm_cr1flag ) { | |
| cclm_cr1delta_idx | |
| } | |
| } | |
| } | |

In table 2 above, the semantics of the syntax elements are as follows:

cclm_flag is similar to the cclm_mode_flag syntax element of VVC specification but is used here for inter blocks. It indicates whether CCLM cross-prediction mode is used to code and decode the current block.

ccp_mode_idx indicates the type of CCLM mode used for the current inter block, as well as the type of neighboring samples used to derive the cross-component prediction linear model, between left, top and top-left reconstructed samples surrounding current block.

cccmAllowed(x0, y0) is a function determining if CCCM mode is enabled for the current block. Typically, CCCM makes use of a selected set of neighboring samples to derive filter parameters. This neighborhood is the same as that indicated by the ccp_mode_idx syntax element. The CCCM mode is thus typically allowed if enough neighboring samples are available in the indicated neighboring region to derive CCCM filter parameters. Note that the present embodiments are not restricted to such rule, and some other CCM enabling rule could apply.

cccm_flag indicates the usage of CCCM mode for the current inter block.

cccm_no_sub_sampling_flag indicates the usage of CCCM mode without any luma down-sampling to predict chroma samples.

gl_cccm_flag indicates the use of GL-CCCM cross-prediction mode for the current inter block.

GlmAllowed(x0, y0) is a function determining if GLM mode is allowed for the current inter block. Typically GLM is allowed if CCCM is not used and if the color format of the video being coded/decoded is 420.

Glm_flag indicates the use of GLM cross-component prediction for the current inter block.

Glm_idx indicates the gradient filter used for gradient computation during GLM cross-component prediction.

cclm_delta_flag indicates the use of CCLM slope adjustment for the current inter block, in the case of an inter block not using CCCM not GLM.

Cclm_cb0_flag indicates the use of slope adjustment in the linear model used for the cross-component prediction of Cb component.

cclm_cr0_flag indicates the use of slope adjustment in the linear model used for the cross-component prediction of Cr component.

cclm_cb0_delta_idx indicates the slope adjustment parameter in the linear model used for the cross-component prediction of Cb component.

cclm_cr0_delta_idx indicates the slope adjustment parameter in the linear model used for the cross-component prediction of Cr component.

Then following flags may be present in the bit-stream in the case of multiple model CCLM cross-prediction mode.

Cclm_cb1_flag indicates the use of slope adjustment in the second linear model used for the cross-component prediction of Cb component.

cclm_cr1_flag indicates the use of slope adjustment in the second linear model used for the cross-component prediction of Cr component.

Cclm_cb1_delta_idx, if present, indicates the slope parameter in the second linear model used for the cross-component prediction of Cb component.

cclm_cr1_delta_idx, if present, indicates the slope parameter in the second linear model used for the cross-component prediction of Cr component.

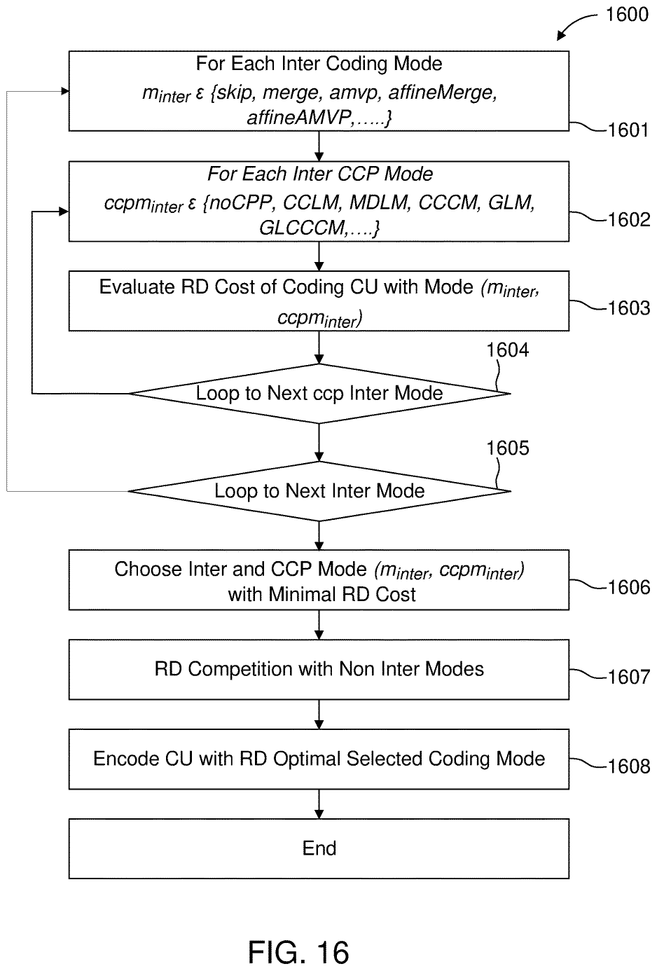

An example of an encoder method 1600 to select the CCP mode for inter CUs is given by FIG. 16. It consists in a double embedded loop (1601, 1602, 1604, 1605) over all inter predictions modes (1601) supported by the codec (skip mode, merge, AMVP, merge affine, AMVP affine, etc.) and on the possible cross-component prediction modes (1602) supported (including CCLM, MMLM, CCCM, GLM, GLCCCM and possibly others). For each couple of inter prediction mode mᵢₙₜₑᵣ and cross-component prediction mode ccpmᵢₙₜₑᵣ, a RD cost is evaluated (1603) for the considered CU. The set of inter prediction and cross-component prediction mode that provides the minimal rate distortion cost is selected (1606). In some embodiments, the non inter modes can also be evaluated for the CU (1607). At 1608, the CU is compressed and encoded with the jointly so-selected inter prediction mode mᵢₙₜₑᵣ and cross-component prediction mode ccpmᵢₙₜₑᵣ.

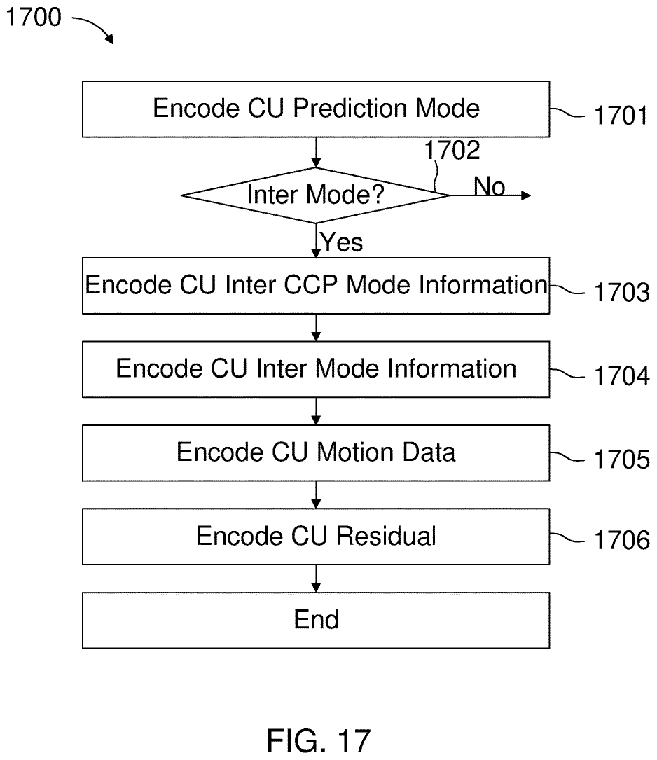

An example of an inter CU entropy coding method (1700) according to this embodiment is illustrated on FIG. 17. The input to the method is a CU to encode for which coding mode and coding parameters have been chosen by an encoder's RD optimization stage.

At 1701, the CU prediction mode is coded to the output bit-stream. Then, at 1702, it is checked whether the CU is inter coded or intra coded. The case of intra CU is not shown here, as not addressed in the embodiments provided herein. At 1703 (the CU is inter coded), the cross-component prediction information used to code the current inter CU is encoded. For example, the bit-stream syntax as proposed in table 1 above can be used. At 1704 and 1705, the CU inter mode information and the associated motion data chosen for the current CU are encoded. At 1706, the CU residual block is coded and the process is done.

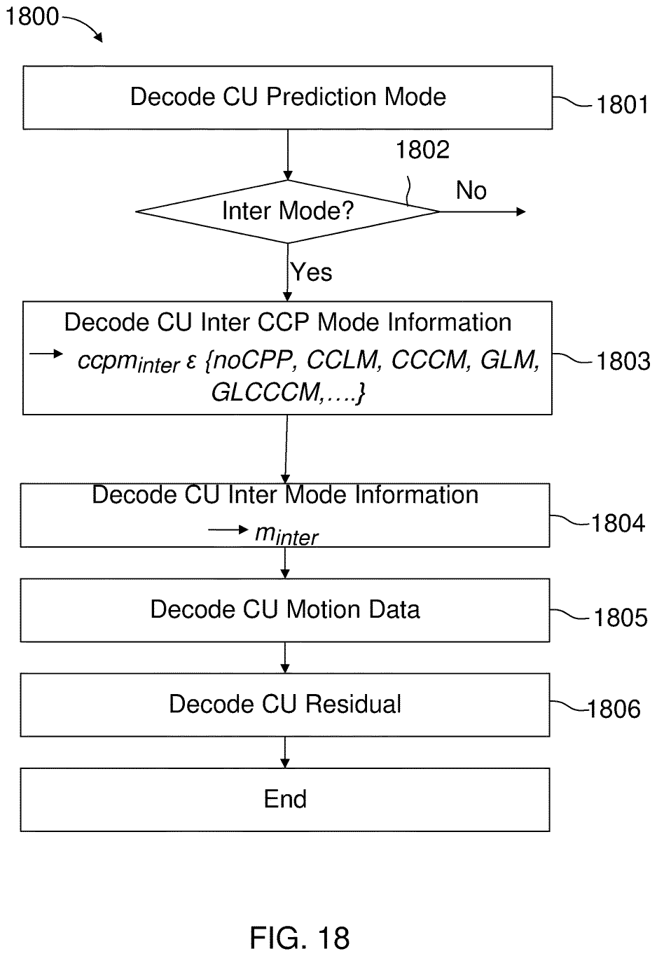

The bit-stream parsing process of an inter CU corresponding reciprocally to the encoding process of FIG. 17 is given on FIG. 18. At 1801, the prediction mode is parsed. Then if inter prediction is used (yes at 1802), the CCP mode selected for the considered CU is parsed (1803), providing CCP mode ccpmᵢₙₜₑᵣ that can be equal to no CCP (meaning that the Cb/Cr component are predicted according to the usual inter prediction), CCLM, CCCM, GLM, GLCCM, and possible any other cross-component prediction modes. In a variant, the CCP mode ccpmᵢₙₜₑᵣ is an index indicating a CCP mode among a set of possible CCP modes. In this variant, a specific value of the index indicates that no CCP mode is used for the given CU. In another variant, for example as illustrated in table 1, a flag first signaled whether CCP mode is used and if the flag indicates so the index is signaled.

The decoded CCP information may also consist in the parameters associated to the considered CCP mode. As an example, if the CCP mode is CCLM, some slope information of the linear model may also be decoded.

At 1804 and 1805, the inter prediction mode and associated motion data are decoded for the current CU, as well as the CU residual (1806).

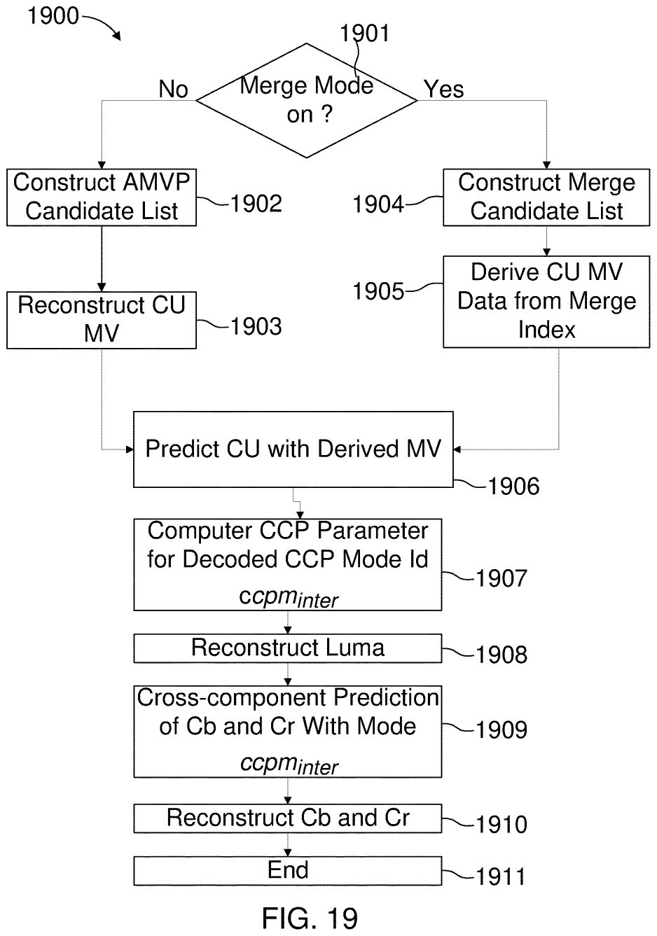

FIG. 19 illustrates an example of a CU decoding and reconstruction process 1900, which is used to reconstruct a CU based on the parsed data issued from the process of FIG. 18. At 1901, it is determined whether the current inter CU is coded in a merge mode or not. If this not the case, at 1902, the AMVP candidate list is constructed and at 1903, the motion data of the current CU is reconstructed from a selected candidate of the AMVP list and decoded motion residual. If the CU is coded in merge, then at 1904, the merge candidate list is constructed and at 1905 the motion data of the current CU is reconstructed from a selected candidate of the merge list. These above steps can be similar as the corresponding ones of a VVC or ECM codecs implementation for instance. At 1906, the CU is predicted from a reference block using the motion data derived in the previous steps.

In this embodiment, the cross-component prediction mode ccpmᵢₙₜₑᵣ used for the inter CU is specified by a decoded CCP mode index, issued from the newly introduced syntax elements inter_ccp_mode( ) introduced in the present disclosure (table 1 and table 2). The CCP mode indicated in the bit-stream may consist in CCLM mode, MMLM mode, CCM mode, GLM mode, GLCCM mode for instance. At 1907, the cross-component mode parameters (e.g. taps of the CCLM mode) are then determined between the predicted luma and predicted chroma blocks determined at 1906. Then the luma is reconstructed at 1908 (by adding the residual to the prediction) and at 1909, CCP is performed using the reconstructed luma and the CCP mode ccpmᵢₙₜₑᵣ to predict the chroma blocks. At 1910, the chroma Cb/Cr blocks are reconstructed by adding the residual and the predicted chroma blocks.

Further embodiments are provided below regarding cross-component prediction mode inheritance for Inter CUs.

According to another embodiment, the cross-component mode used for an inter CU may be inherited from some other already coded or decoded CUs.

To do so, a list of candidate CCP modes can be constructed for a current CU to decode, based on already decoded CUs. The candidate list may consist in CCP modes of spatial neighboring candidates, non-adjacent candidates, history-based candidates from current picture, and possibly temporal candidates, typically from same collocated picture as used for temporal motion data inheritance. The CCP mode derivation may thus also apply to the temporal merge derivation. In this case, the merge_idx would indicate that the CCP mode of a collocated inter block of current block, if available in collocated picture, is used to derive the CCP mode of current inter block. Note the collocated block may be determine similarly as what is already done for temporal merge candidate derivation, typically for TMVP or SbTMVP merge candidates of VVC or ECM.

To identify the CCP mode selected for a current CU, a dedicated ccp_merge_idx syntax element can be used to indicate the candidate CCP selected in the list.

According to a variant, the use of this merge CCP signaling mode can be used within the merge and affine merge modes of a considered video codec.

On the other hand, in case of an AMVP inter CU, the explicit signaling of the CCP mode for current CU is applied.

The advantage of this embodiment is to further increase the compression efficiency by reducing the signaling cost of CCP mode information, compared to the embodiment provided above.

An example of a corresponding syntax table for the CU prediction data is given by table 3, with added elements shown in bold.

TABLE 3
CU prediction data syntax table with CCP data inheritance

| | Descriptor |
|---|---|
| coding_unit( x0, y0, cbWidth, cbHeight, cqtDepth, treeType, modeType ) { | |
| if( sh_slice_type = = I && ( cbWidth > 64 \|\| cbHeight > 64 ) ) | |
| modeType = MODE_TYPE_INTRA | |
| chType = treeType = = DUAL_TREE_CHROMA ? 1 : 0 | |
| if( sh_slice_type != I \|\| sps_ibc_enabled_flag ) { | |
| if( treeType != DUAL_TREE_CHROMA && | |
| ( ( !( cbWidth = = 4 && cbHeight = = 4 ) && | |
| modeType != MODE_TYPE_INTRA ) \|\| | |
| ( sps_ibc_enabled_flag && cbWidth <= 64 && cbHeight <= 64 ) ) ) | |
| cu_skip_flag[ x0 ][ y0 ] | ae(v) |
| if( cu_skip_flag[ x0 ][ y0 ] = = 0 && sh_slice_type != I && | |
| !( cbWidth = = 4 && cbHeight = = 4 ) && modeType = = | |
| MODE_TYPE_ALL ) | |
| pred_mode_flag | ae(v) |
| if( ( ( sh_slice_type = = I && cu_skip_flag[ x0 ][ y0 ] = = 0 ) \|\| | |
| ( sh_slice_type != I && ( CuPredMode[ chType ][ x0 ][ y0 ] != | |
| MODE_INTRA \|\| | |
| ( ( ( cbWidth = = 4 && cbHeight = = 4) \|\| modeType = = | |
| MODE_TYPE_INTRA ) | |
| && cu_skip_flag[ x0 ][ y0 ] = = 0 ) ) ) ) && | |
| cbWidth <= 64 && cbHeight <= 64 && modeType != | |
| MODE_TYPE_INTER && | |
| sps_ibc_enabled_flag && treeType != DUAL_TREE_CHROMA ) | |
| pred_mode_ibc_flag | ae(v) |
| } | |
| [ ... ] | |
| if( CuPredMode[ chType ][ x0 ][ y0 ] = = MODE_INTRA \|\| | |
| CuPredMode[ chType ][ x0 ][ y0 ] = = MODE_PLT ) { | |
| [ ... ] | |
| } else if( treeType != DUAL_TREE_CHROMA ) { /* MODE_INTER or MODE_IBC | |
| */ | |
| if( cu_skip_flag[ x0 ][ y0 ] = = 0 ) | |
| general_merge_flag[ x0 ][ y0 ] | ae(v) |
| if( general_merge_flag[ x0 ][ y0 ] ) { | |
| merge_data( x0, y0, cbWidth, cbHeight, chType ) | |
| If( CcpAllowed( x0 , y0 ) { | |
| ccp_merge_idx | ae(v) |
| } | |
| } | |
| else if( CuPredMode[ chType ][ x0 ][ y0 ] = = MODE_IBC ) { | |
| [...] | ae(v) |
| } else { | |
| If( CcpAllowed( x0 , y0 ) { | |
| inter_ccp_mode_flag[ x0 ][ y0 ] | ae(v) |
| if( inter_ccp_mode_flag[ x0 ][ y0 ] = = 1 ) { | |
| Inter_ccp_mode | |
| ( x0, y0, cbWidth, cbHeight, cqtDepth, treeType, modeType ) | |
| } | |
| } | |
| } | |
| [... ] // AMVP motion data signaling | |
| } | |
| } | |
| [ ...] // CU residual data signaling | |
| } | |

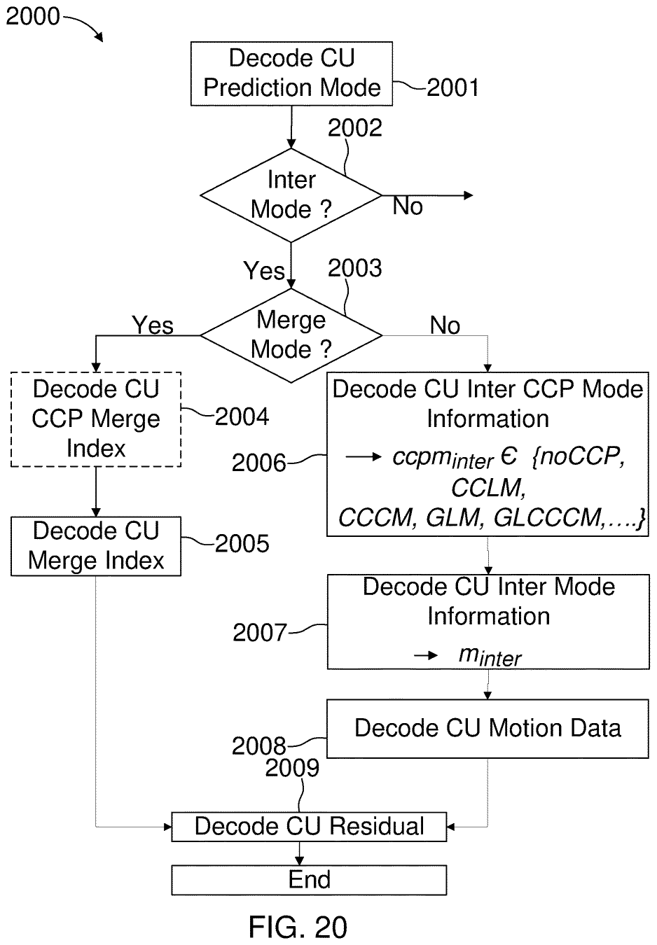

The bitstream parsing (2000) of CU prediction and CCP data corresponding to this embodiment is given by FIG. 20. At 2001, the CU prediction mode is decoded and it is checked at 2002 whether the CU is coded in inter mode or not. Only the inter CUs are considered here. As can be seen, based on whether the CU is in merge mode or not (2003), different parsing of CCP information takes place. In the case of AMVP mode, the same parsing (2006, 2007, 2008, 2009) as in the embodiment provided in reference with FIG. 18 applies. In the case of the merge mode, the CCP merge index is parsed (2004), as well as the usual merge index used to derive CU motion data (2005). The CU residual is decoded at 2009.

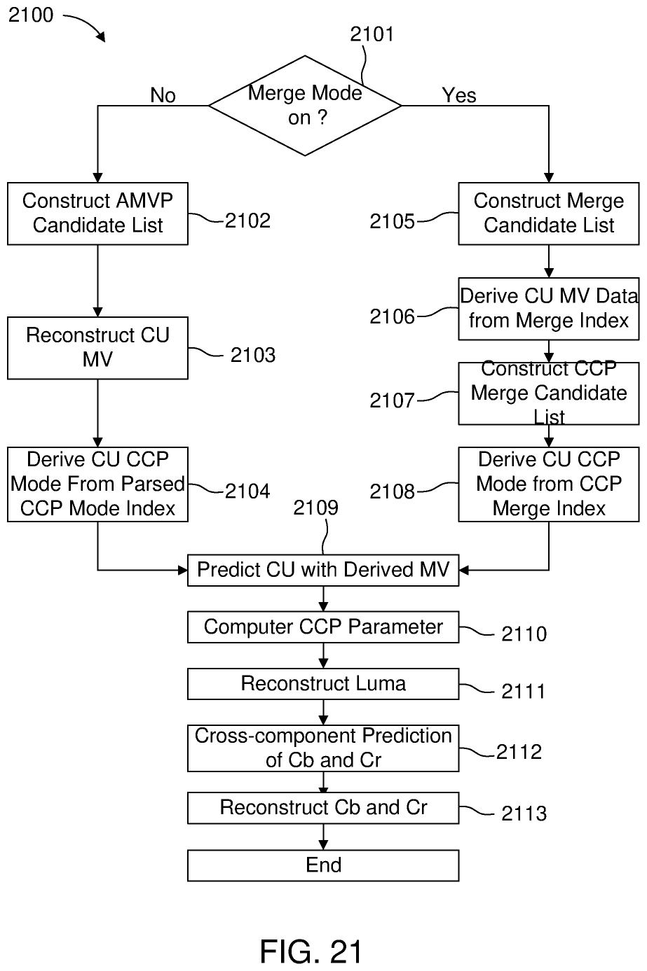

An example of a CU decoding and reconstruction process (2100) based on motion and CCP data parsed in FIG. 20 is provided on FIG. 21. At 2101, it is determined whether the current inter CU is coded in a merge mode or not. If this not the case, at 2102, the AMVP candidate list is constructed according to the coded standard or implementation and at 2103, thotion data of the current CU is reconstructed from a selected candidate of the AMVP list and decoded motion residual. At 2104, the CCP mode for the inter CU is derived from the parsed CCP mode index.

If the CU is coded in merge mode, then at 2105, the merge candidate list is constructed. At 2106, the CU motion data is derived from the candidate selected in the merge candidate list using the decoded merge index of the CU. In this embodiment, at 2107, the CCP merge candidate list is constructed for the inter CU, and at 2108, the CCP mode is derived from a candidate selected from the CCP merge candidate list according to the parsed CCP merge index.

The subsequent steps 2109-2113 to reconstruct the current CU are similar to the ones of FIG. 19.

Some variants of the above embodiment are provided below.

The CCP mode derivation may only apply when the CU is in skip mode. A CU in skip is equivalent to a CU coded in merge mode, except its associated residual block is not coded and is equal to 0. In such case, the CU inherits the CCP mode from a merge candidate selected in a candidate list, similarly as for motion information.

In another variant, the CCP mode chosen for the CU is the CCP mode minimizing a distortion between the filtered predicted luma block and the temporally predicted chroma block. In this variant, no signaling of the CCP mode used for inter CUs is needed, and no new syntax for signaling the CCP mode and parameter needs to be introduced.

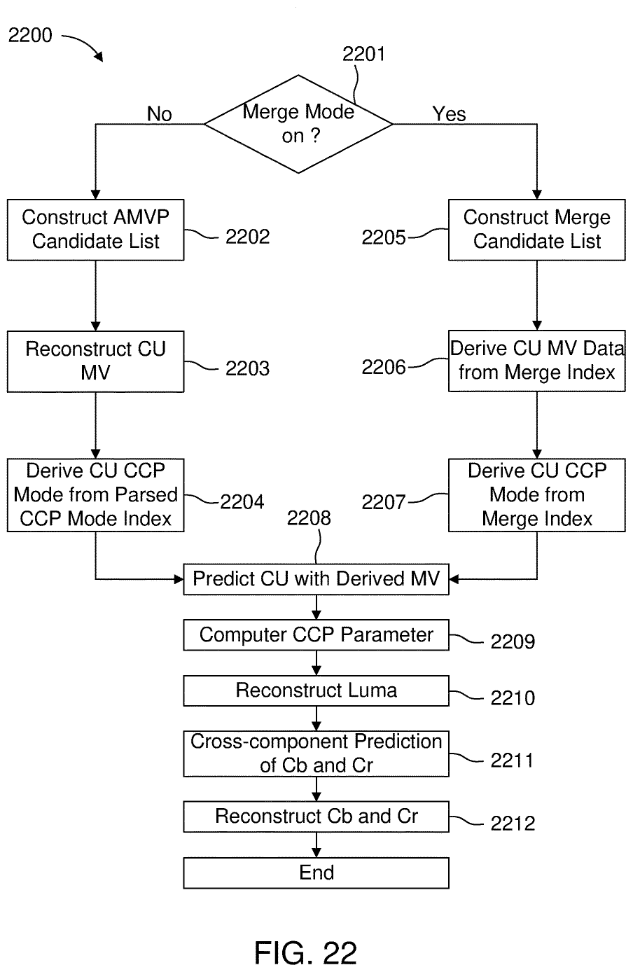

According to another variant, a single candidate list is constructed at encoder and decoder side, and each candidate in the list consists in motion data as well as CCP mode information. According to this variant, no new merge index ccp_merge_idx syntax element is used, but the single merge index already used for motion data is also used to inherit the CCP mode information. Such variant has the advantage of increased coding efficiency. It is illustrated on FIG. 22. Steps of FIG. 22 are similar as the ones of FIG. 21 except that in FIG. 22, the CCP merge candidate list is not constructed, and the same merge candidate list determined for motion data at 2205 and parsed merge index are used to derive the CCP mode at 2207.

In another variant, not only the CCP mode but also the CCP prediction parameters, (e.g. CCCM filtering parameters, CCLM slope parameter, etc.) are derived from a past CU indicated by the merge index in the candidate list. In this case, computed CCP parameter are stored at CU level, and can be re-used for the decoding of subsequent CUs.

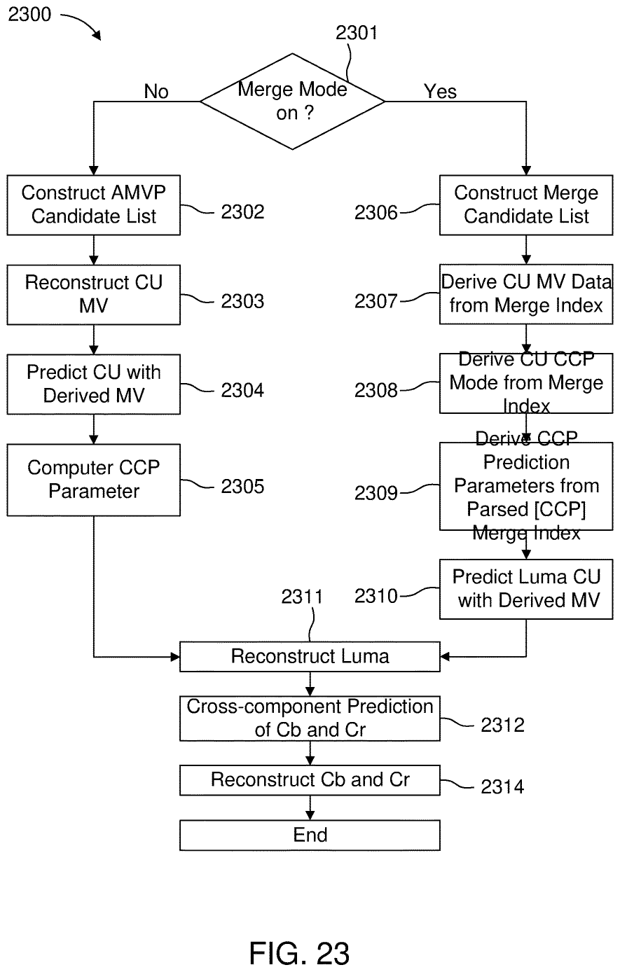

This variant is illustrated by an example CU decoding and reconstruction process 2300 on FIG. 23. The advantage of this variant is to save computation by avoiding computing CCP prediction parameter from the predicted luma and chroma block for each CU. In this variant, the CCP parameters are computed only when the CU is coded in an AMVP mode and the CCP parameters are derived from a CCP candidate when the CU is in merge mode.

Another advantage is to make it possible to apply CCP in inter blocks coded in merge skip mode, which is not achieved in prior art. Indeed, by inheriting merge candidate CCP mode and parameter, a CU in skip mode, i.e. which does not have any associated residual block can still benefit from potentially improved chroma prediction through the proposed merge mechanism extended to CCP mode and parameters.

At 2301, it is determined whether the current inter CU is coded in a merge mode or not. If this not the case, at 2302, the AMVP candidate list is constructed according to the coded standard or implementation and at 2303, the motion data of the current CU is reconstructed from a selected candidate of the AMVP list and decoded motion residual. At 2304, the CU is predicted using the derived motion data and reference picture. At 2305, the CCP mode is derived from the parsed CCP mode index and the CCP parameter are determined from the predicted CU. If the CU is coded in merge mode, then at 2306, the merge candidate list is constructed. At 2307, the CU motion data is derived from the candidate selected in the merge candidate list using the decoded merge index of the CU. In this embodiment, at 2308, the CCP mode is derived from the merge index that was used also for the merge motion. In another variant, the CCP mode can be derived from a CCP mode candidate selected from a CCP merge candidate list using a parsed CCP mode index.

In any of these variants, at 2309, the CCP prediction parameters of the CCP mode determined at 2308 are derived from the candidate indicated by the merge index or the CCP merge index depending on the variants used. At 2310, the CU is predicted using the derived motion data and reference picture as in 2304.

The subsequent steps 2311-2314 to reconstruct the current CU are similar to the corresponding ones of FIG. 19 or 22.

In a variant, these CCP parameters may only be inherited when a spatially adjacent merge candidate is used for derivation.

In another variant, the derivation of the CCP mode from a candidate selected in the CCP merge candidate list may only apply when the merge candidate used for deriving the motion data corresponds to a spatial neighboring block of the current block. In that variant, no non-adjacent merge candidate may be used to derive the CCP mode of a given inter block. In another variant, the CCP mode derivation may only apply when the CU is in skip mode. In a variant of the above embodiments for the merge derivation of the CCP mode, the proposed CCP mode signaling and derivation in merge mode may take place only for the Inter CU (that is the blocks coded in inter mode), and not for the blocks or coding units that coded in a IBC (Intra Block Copy) coding mode.

Alternatively, the proposed CCP mode signaling and derivation in merge mode in any of the embodiments described above may be allowed both for the inter case and the IBC case.

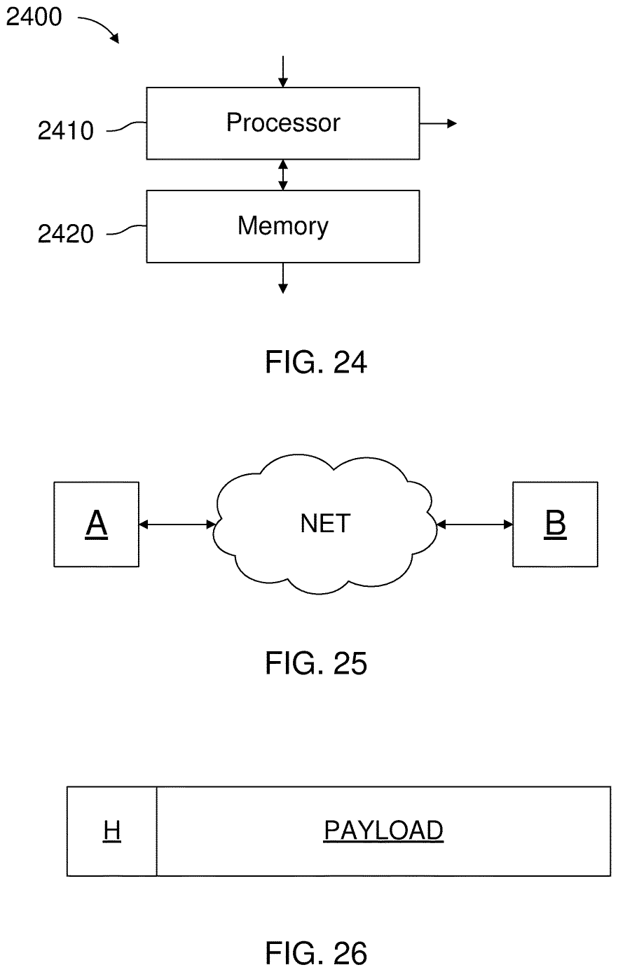

FIG. 24 illustrates a block diagram of a system within which aspects of the present embodiments may be implemented, according to another embodiment. FIG. 24 shows one embodiment of an apparatus 2400 for encoding or decoding a video according to any one of the embodiments described herein. The apparatus comprises Processor 2410 and can be interconnected to a memory 2420 through at least one port. Both Processor 2410 and memory 2420 can also have one or more additional interconnections to external connections.

Processor 2410 is also configured to, using any one of the embodiments described herein. For instance, the processor 1220 is configured to decode one or more syntax elements for a block of the video, the video block being coded in an inter coding mode, derive a cross-component prediction mode for the video block from the one or more syntax elements, reconstruct a luma component for the video block, and reconstruct one or more chroma components for the video block from the reconstructed luma component using the cross-component prediction mode, using any one of the embodiments described herein. For instance, the processor 2410 using a computer program product comprising code instructions that implements any one of embodiments described herein.

In other embodiments, Processor 2410 is configured to reconstruct a luma component of a block of the video, the video block being coded in an inter coding mode, determine a cross-component prediction mode for the video block, encode one or more syntax elements for the video block, the one or more syntax elements providing for deriving the cross-component prediction mode on the decoder side, and encode the chroma component of the video block based on the reconstructed luma component and the determined cross-component prediction mode, using any one of the embodiments described herein. For instance, the processor 2410 is configured using a computer program product comprising code instructions that implements any one of embodiments described herein.

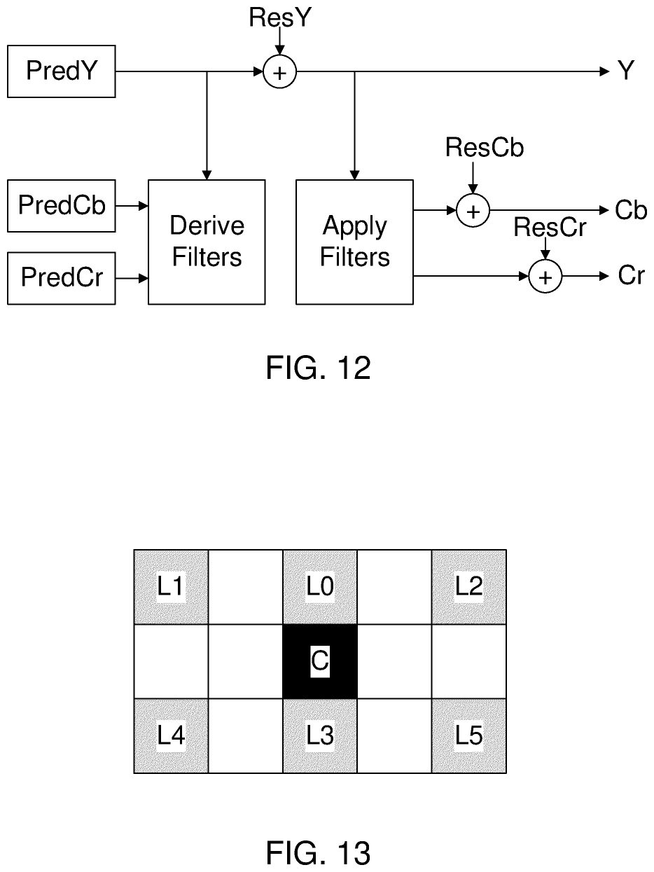

In an embodiment, illustrated in FIG. 25, in a transmission context between two remote devices A and B over a communication network NET, the device A comprises a processor in relation with memory RAM and ROM which are configured to implement a method for encoding a video, as described with FIG. 1-24 and the device B comprises a processor in relation with memory RAM and ROM which are configured to implement a method for decoding a video as described in relation with FIG. 1-24. In accordance with an example, the network is a broadcast network, adapted to broadcast/transmit a coded video from device A to decoding devices including the device B.

FIG. 26 shows an example of the syntax of a signal transmitted over a packet-based transmission protocol. Each transmitted packet P comprises a header H and a payload PAYLOAD. In some embodiments, the payload PAYLOAD may comprise video data encoded according to any one of the embodiments described above.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, entropy decoding a sequence of binary symbols to reconstruct image or video data.

As further examples, in one embodiment “decoding” refers only to entropy decoding, in another embodiment “decoding” refers only to differential decoding, and in another embodiment “decoding” refers to a combination of entropy decoding and differential decoding, and in another embodiment “decoding” refers to the whole reconstructing picture process including entropy decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining re-sampling filter coefficients, re-sampling a decoded picture.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art. Note that the syntax elements as used herein, are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Some embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

A number of embodiments has been described above. Features of these embodiments can be provided alone or in any combination, across various claim categories and types.

1. A method comprising:
responsive to a determination that a video block is coded in an inter coding mode,
constructing a candidate list for the video block for deriving a cross-component prediction mode for the video block, wherein the candidate list comprises cross-component prediction mode candidates,
selecting a cross-component prediction mode for the video block from the candidate list,
reconstructing a luma component for the video block, and
reconstructing one or more chroma components for the video block from the reconstructed luma component using the cross-component prediction mode.

2. An apparatus, comprising one or more processors, wherein the one or more processors are operable to:
responsive to a determination that a video block is coded in an inter coding mode, construct a candidate list for the video block for deriving a cross-component prediction mode for the video block, wherein the candidate list comprises cross-component prediction mode candidates,
select a cross-component prediction mode for the video block from the candidate list,
reconstruct a luma component for the video block, and
reconstruct one or more chroma components for the video block from the reconstructed luma component using the cross-component prediction mode.

3. A method, comprising:
reconstructing a luma component of a video block, the video block being coded in an inter coding mode,
constructing a candidate list for the video block for deriving a cross-component prediction mode for the video block, wherein the candidate list comprises cross-component prediction mode candidates;
selecting a cross-component prediction mode for the video block from the candidate list, and
encoding one or more chroma components of the video block based on the reconstructed luma component and the selected cross-component prediction mode.

4. An apparatus, comprising one or more processors, wherein the one or more processors is operable to
reconstruct a luma component of a video block, the video block being coded in an inter coding mode,
construct a candidate list for the video block for deriving a cross-component prediction mode for the video block, wherein the candidate list comprises cross-component prediction mode candidates;
select a cross-component prediction mode for the video block from the candidate list, and
encode one or more chroma components of the video block based on the reconstructed luma component and the selected cross-component prediction mode.

5. The method of claim 1, wherein an index is decoded for the video block, the index indicating a candidate in the candidate list for deriving the cross-component prediction modes.

6. The method of claim 1, wherein the cross-component prediction modes comprises at least one of a Convolutional Cross-Component Model, a Cross-component Linear Model, a Multi-Model Linear Model, or a Gradient Linear Model.

7. (canceled)

8. The method of claim 1, wherein the candidate list comprises a temporal block from a reference picture.

9. The method of claim 1, wherein the cross-component prediction mode is selected from the candidate list for the video block using a template of the video block.

10. The method of claim 5, wherein a flag is decoded indicating whether a cross-component prediction mode is used or not for the video block coded in an inter coding mode, and wherein selecting the cross-component prediction mode is responsive to a determination that the flag indicates use of a cross-component prediction mode for the video block.

11-14. (canceled)

15. The method of claim 1, wherein responsive to a determination that the video block is in a merge mode or in a skip mode, motion data for the video block being derived from a selected candidate in a merge candidate list, the cross-component prediction mode is inherited from the selected candidate block.

16-20. (canceled)

21. A non-transitory computer readable medium storing executable program instructions to cause a computer executing the program instructions to perform a method according to claim 1.

22-25. (canceled)

26. The method of claim 5, wherein use of a cross component prediction mode for the video block is further responsive to a determination that the video block is coded in an inter merge mode or in an intra block copy mode or in an inter AMVP mode.

27. The method of claim 9, wherein the candidate list is a merge candidate list constructed for the video block for deriving motion data for the video block.

28. The apparatus of claim 2, wherein a flag is decoded indicating whether a cross-component prediction mode is used or not for the video block coded in an inter coding mode, and wherein selecting the cross-component prediction mode is responsive to a determination that the flag indicates use of a cross-component prediction mode for the video block.

29. The apparatus of claim 2, wherein one or more parameters relating to the cross-component prediction mode are decoded.

30. The apparatus of claim 2, wherein use of a cross component prediction mode for the video block is further responsive to a determination that the video block is coded in an inter merge mode, or in an intra block copy mode, or an inter AMVP mode.

31. The apparatus of claim 2, wherein the candidate list is a merge candidate list constructed for the video block for deriving motion data for the video block.

32. The apparatus of claim 2, wherein responsive to a determination that the video block is in a merge mode or in a skip mode, motion data for the video block being derived from a selected candidate in a merge candidate list, the cross-component prediction mode is inherited from the selected candidate block.

33. The apparatus of claim 4, wherein an index is encoded for the video block, the index indicating a candidate in the candidate list for deriving the cross-component prediction mode.

34. The apparatus of claim 4, wherein the candidate list is a merge candidate list constructed for the video block for deriving motion data for the video block.
